(19) United States
(12) Patent Application Publication
(10) Pub. No.: US 2026/0081442 A1
(43) Pub. Date: Mar. 19, 2026

(54) POWER CONVERSION DEVICE AND POWER STORAGE SYSTEM

(71) Applicant: FUJI ELECTRIC CO., LTD., Kanagawa (JP)

(72) Inventors: Ryuji YAMADA, Hachioji-city (JP); Kazuyuki YODA, Kobe-city (JP)

(21) Appl. No.: 19/308,279

(22) Filed: Aug. 24, 2025

Related U.S. Application Data
(63) Continuation of application No. PCT/JP2024/033180, filed on Sep. 18, 2024.

(51) Int. Cl. H02J 7/00; H02M 1/32

(52) U.S. Cl. CPC H02J 7/62; H02J 7/855; H02J 7/90; H02M 1/32; H02J 2207/20

(57) ABSTRACT

There is provided a power conversion device including: a non-isolated DC-DC converter provided between a battery and a DC bus to which one or more batteries are connected and a bus voltage is applied; and current limiting means which limits at least one of an input current to the non-isolated DC-DC converter or an output current from the non-isolated DC-DC converter, in which the non-isolated DC-DC converter performs an operation to convert a battery voltage of the battery to the bus voltage for outputting to the DC bus when the battery is discharged, and performs an operation to convert the bus voltage to the battery voltage for outputting to the battery when the battery is charged, and the current limiting means is connected between the non-isolated DC-DC converter and the battery, or between the non-isolated DC-DC converter and the DC bus.

The contents of the following patent application(s) are incorporated herein by reference:
NO. PCT/JP2024/033180 filed in WO on Sep. 18, 2024.

### BACKGROUND

### 1. TECHNICAL FIELD

The present invention relates to a power conversion device and a power storage system.

### 2. RELATED ART

In the related art, a switching power supply apparatus having overcurrent protecting means is known (refer to Patent Document 1). In addition, a switching power supply is known to be capable of making the mean value of inductor currents almost constant even if a load is put into an overcurrent or short-circuited state, and suppressing the change of oscillation frequency to the minimum (refer to Patent Document 2).

### RELATED ART DOCUMENTS

### Patent Document

Patent Document 1: Japanese Patent Application Publication No. 2003-047237

Patent Document 2: Japanese Patent Application Publication No. 2005-210822

### BRIEF DESCRIPTION OF THE DRAWINGS

FIG. 1 is a diagram showing an example of a power storage system 100 including a power conversion device 10 in a first example of the present invention.

FIG. 2 is an enlarged diagram of the power conversion device 10, a battery 20, and a DC bus 30.

FIG. 3 is a diagram showing an example of a current limiting operation of the power conversion device 10 in FIG. 2.

FIG. 4 is a diagram showing another example of the current limiting operation of the power conversion device 10 in FIG. 2.

FIG. 5 is a diagram showing another arrangement example of the power conversion device 10, the battery 20, and the DC bus 30.

FIG. 6 is a diagram showing an example of the current limiting operation of the power conversion device 10 in FIG. 5.

FIG. 7 is a diagram showing another example of the current limiting operation of the power conversion device 10 in FIG. 5.

FIG. 8 is a diagram showing another configuration example of the power conversion device 10.

### DESCRIPTION OF EXEMPLARY EMBODIMENTS

Hereinafter, the invention will be described through embodiments of the invention, but the following embodiments do not limit the invention according to claims. In addition, not all of the combinations of features described in the embodiments are essential to the solving means of the invention.

In the present specification, an expression such as being “connected” is not limited to being directly connected without another element being interposed, and includes being indirectly connected via another element. In addition, in the present specification, an expression such as being “connected between . . . and . . . ”, being “provided between . . . and . . . ”, or “arranged between . . . and . . . ” does not limit a physical arrangement, and means being “electrically connected to . . . and . . . ”.

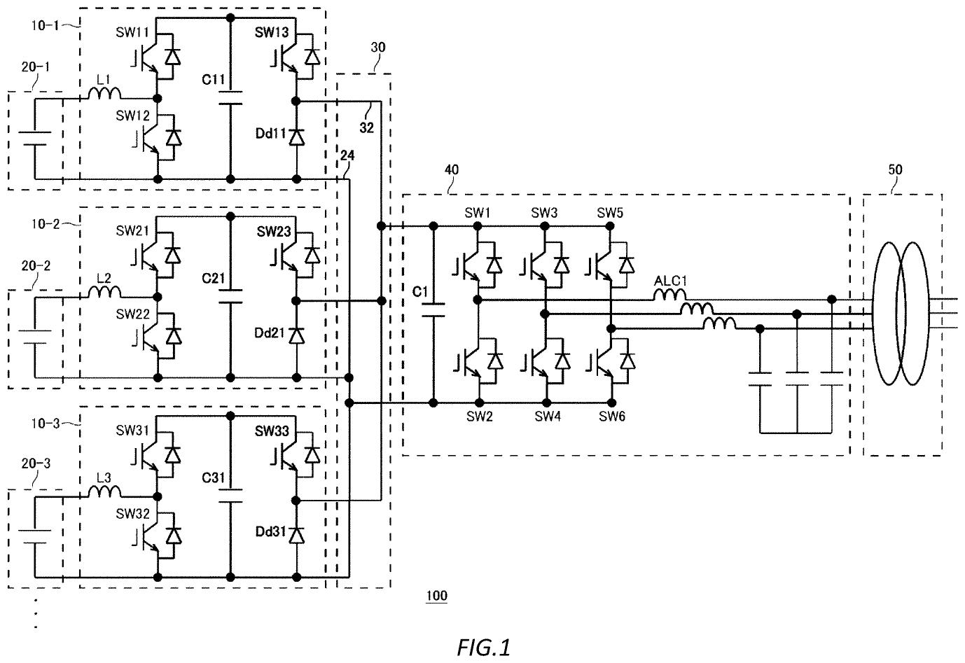

FIG. 1 is a diagram showing an example of a power storage system 100 including a power conversion device 10 in a first example of the present invention. The power storage system 100 is connected to a power facility, stores power from the power facility, and also supplies the power to the power facility. The power facility may include, for example, a power generation facility using renewable energy. The power storage system 100 stores surplus power from the power generation facility, and also supplies the power from the power storage system 100 when there is a shortage of power in the power generation facility. The power facility may be a power system. The power storage system 100 supplies the power to the power system and stores the power from the power system.

The power storage system 100 includes one or more power conversion devices 10, one or more batteries 20, a DC bus 30, a power conditioner 40, and a transformer 50. The power storage system 100 may include a plurality of power conversion devices 10 and a plurality of batteries 20. The battery 20 may be a secondary battery. The battery 20 outputs a predetermined battery voltage. The power conversion device 10 is provided for each battery 20. In other words, each power conversion device 10 is connected to the battery 20.

The power conversion device 10 is provided between the battery 20 and the DC bus 30. The power conversion device 10 converts (for example, steps up) a battery voltage to a bus voltage that is a voltage of the DC bus 30. The battery voltage is a voltage at an output terminal of the battery 20. The power conversion device 10 may convert (for example, step down) the bus voltage to the battery voltage to charge the battery. The power conversion device 10 includes a non-isolated DC-DC converter. In FIG. 1, three power conversion devices 10 and three batteries 20 are shown; however, the power storage system 100 may have more or fewer power conversion devices 10 and batteries 20. A structure of the power conversion device 10 will be described below.

To the DC bus 30, one or more batteries 20 are connected and the bus voltage is applied. In a case of the present example, the power conversion device 10 is provided for the battery 20, and thus the plurality of power conversion devices 10 are connected to the DC bus 30 which is common. Each power conversion device 10 may be operated to maintain the bus voltage of the DC bus 30 at a predetermined value. The DC bus 30 in the present example has a high potential line 32 and a reference potential line 24. The reference potential line 24 is connected to a terminal of each battery 20 on a low voltage side. The high potential line 32 is connected to an output terminal of each power conversion device 10. The bus voltage in the present example is a voltage at the high potential line 32.

The power conditioner 40 performs a conversion between DC power and AC power. The power conditioner 40 is connected to the DC bus 30 and the transformer 50. The power conditioner 40 converts the DC power from the DC bus 30 into the AC power, and supplies it to the transformer 50. In addition, the power conditioner 40 converts the AC power from the transformer 50 into the DC power, and supplies it to the DC bus 30. The power conditioner 40 in the present example has a capacitor C1 which is charged by the bus voltage of the DC bus 30 or a voltage from the transformer. The power conditioner 40 in the present example includes a three-phase inverter which converts the DC power from the capacitor C1 into the AC power, and converts the AC power from the transformer into the DC power. The three-phase inverter has switches SW1 to SW6; and the switches SW1 and SW2, the switches SW3 and SW4, and the switches SW5 and SW6 respectively correspond to arms of the three-phase inverter. An inductor ALC1 is connected to a connection point of the switches in each arm. A capacitor may be provided between each inductor ALC1 and a reference potential. Note that a structure of the power conditioner 40 is not limited to this. The power conditioner 40 only needs to be able to convert the DC power and AC power to each other.

The transformer 50 converts a voltage of the AC power. The transformer 50 converts the voltage of the AC power output from the power conditioner 40, and outputs it to the power facility. In addition, the transformer 50 converts the voltage of the AC power from the power facility, and outputs it to the power conditioner 40.

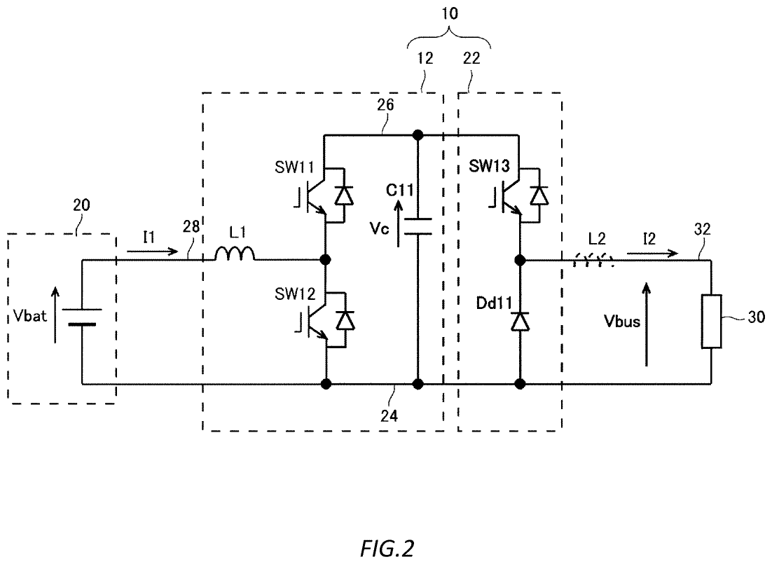

FIG. 2 is an enlarged diagram of the power conversion device 10, the battery 20, and the DC bus 30 in FIG. 1. The power conversion device 10 includes a non-isolated DC-DC converter 12 and current limiting means 22. The non-isolated DC-DC converter 12 is provided between the battery 20 and the DC bus 30. The non-isolated DC-DC converter 12 performs an operation to convert (step up) a battery voltage Vbat of the battery 20 to a bus voltage Vbus that is higher than the battery voltage Vbat for outputting to the DC bus 30 when the battery 20 is discharged; and performs an operation to convert (step down) the bus voltage Vbus to the battery voltage Vbat for outputting to the battery 20 when the battery 20 is charged. Here, the battery voltage Vbat when the battery 20 is discharged may be an output voltage of the battery 20, and the battery voltage Vbat when the battery 20 is charged may be a charge voltage of the battery 20.

The non-isolated DC-DC converter 12 has an inductor L1, a capacitor C11, and a conversion switch SW12. A current I1 flows through the inductor L1 from the battery 20. The conversion switch SW12 switches between supplying and not supplying the current of the inductor L1 to the capacitor C11, and converts the voltage. The non-isolated DC-DC converter 12 may further have a step-down switch SW11 for a step-down operation which is arranged between the inductor L1 and the capacitor C11. The inductor L1 is an inductor used for the step-up and step-down, and may be different from an inductance component of wiring. The conversion switch SW12 and the step-down switch SW11 may be MOSFETs or may be IGBTs. In the present specification, wiring or a terminal through which the current flows into the non-isolated DC-DC converter 12 may be referred to as an input unit of the non-isolated DC-DC converter 12; and wiring or a terminal through which the current flows out is referred to as an output unit of the non-isolated DC-DC converter 12. In FIG. 2, the wiring which connects the battery 20 to the non-isolated DC-DC converter 12 is an input unit 28; and a high potential line 26 on a DC bus 30 side which will be described below, is an output unit.

The power conversion device 10 includes the reference potential line 24 set to a reference potential, and the high potential line 26 which has a potential higher than the reference potential by a voltage Vc of the capacitor C11. The reference potential may be a ground potential. The capacitor C11 is arranged between the high potential line 26 and the reference potential line 24. One end of the capacitor C11 is connected to the high potential line 26 between the step-down switch SW11 and a limiting switch SW13 described below. The reference potential line 24 may be common to the battery 20 and the DC bus 30. The high potential line 26 may be connected to the high potential line 32 of the DC bus 30 via the limiting switch SW13 described below.

During the step-up of the non-isolated DC-DC converter 12, the conversion switch SW12 is turned on and off repeatedly. In the present specification, the switch being turned on and off repeatedly may be referred to as switching. When the conversion switch SW12 is turned on, the current I1 from the battery 20 flows to the inductor L1, and energy is stored in the inductor L1. When the conversion switch SW12 is turned off, the energy stored in the inductor L1 and the energy from the battery 20 are stored in the capacitor C11. The energy from the inductor L1 and the battery 20 is transmitted to the capacitor C11 through a freewheeling diode of the step-down switch SW11. The voltage Vc of the capacitor C11 is stepped up by the conversion switch SW12 repeatedly being turning on and off. The capacitor C11 supplies the voltage Vc to the DC bus 30. In this manner, the non-isolated DC-DC converter 12 steps up the battery voltage Vbat to the bus voltage Vbus.

That is, during the step-up, the non-isolated DC-DC converter 12 in the present example is operated as a step-up chopper circuit.

During the step-down of the non-isolated DC-DC converter 12, the step-down switch SW11 is turned on and off repeatedly. When the step-down switch SW11 is turned on, the current flows from the DC bus 30 or the capacitor C11 towards the battery 20, the energy is stored in the inductor L1, and the energy is supplied to the battery 20 as well. When the step-down switch SW11 is turned off, the energy stored in the inductor L1 is supplied to the battery 20.

While the step-down switch SW11 is turned off, the energy from the inductor L1 flows through a loop of the battery 20, the conversion switch SW12, and inductor L1, via the freewheeling diode of the conversion switch SW12. By the step-down switch SW11 being turned on and off repeatedly, the battery 20 is charged at the battery voltage Vbat that is lower than the bus voltage Vbus.

That is, during the step-down, the non-isolated DC-DC converter 12 in the present example is operated as a step-down chopper circuit.

When at least one of an input current to the non-isolated DC-DC converter 12 or an output current from the non-isolated DC-DC converter 12 becomes an overcurrent, the current limiting means 22 limits at least one of the input current or the output current. In FIG. 2, the input current during the step-up operation is indicated as I1, and the output current is indicated as I2. During the step-down operation, a current in a reverse direction of the current I1 is the output current, and a current in a reverse direction of the current I2 is the input current. The current limiting means 22 may be connected between the non-isolated DC-DC converter 12 and the battery 20, or between the non-isolated DC-DC converter 12 and the DC bus 30. The current limiting means 22 in the present example is connected between the capacitor C11 and the DC bus 30.

The current limiting means 22 in the present example limits the current I2. The current limiting means 22 may be a semiconductor switch such as a transistor which will be described below. In addition, the current limiting means 22 may further have a mechanical switch that is not shown. The mechanical switch may be opened after a current limiting operation of the current limiting means 22 described below, to electrically separate a cause of a generation of the overcurrent from the non-isolated DC-DC converter 12. This makes it possible to bring the circuit into an open state completely, and makes it possible to provide a double protection for the power conversion device 10 or the like at a time of a destruction of the current limiting means 22.

When a non-isolated DC-DC converter of the step-up type is used for the battery, short circuit impedance of the battery is small, and a DC-DC converter of the step-up type itself does not have a function of limiting the output current, and thus the overcurrent flows when the DC bus 30 is short-circuited or the like. In the case of the non-isolated DC-DC converter 12 in the present example, when the DC bus 30 is short-circuited, the overcurrent flows from the battery 20 through the inductor L1 and the freewheeling diode of the step-down switch SW11. By providing the current limiting means 22, it is possible to protect the battery 20, the non-isolated DC-DC converter 12, and the DC bus 30 from the overcurrent.

The current limiting means 22 limits at least one of the input current or the output current, independently of the conversion operation of the non-isolated DC-DC converter 12. Being independent of the conversion operation of the non-isolated DC-DC converter 12 may refer to limiting the current at a timing or a reference different from those of the step-up and step-down operation of the non-isolated DC-DC converter 12, or may refer to limiting the current by another element different from the non-isolated DC-DC converter 12.

The current limiting means 22 in the present example is a circuit in which the limiting switch SW13 which limits the current and a freewheeling diode Dd11 are connected in series. The limiting switch SW13 is connected to the input unit or the output unit of the non-isolated DC-DC converter 12. The limiting switch SW13 in the present example is connected to the output unit of the non-isolated DC-DC converter 12, and is connected to the capacitor C11. The freewheeling diode Dd11 is provided between the limiting switch SW13 and the reference potential line 24. The freewheeling diode Dd11 has a role of ensuring a current path of the current flowing through a current limiting inductor L2 which will be described below, during an off period of the limiting switch SW13. The freewheeling diode Dd11 in the present example has a cathode connected to the limiting switch SW13 and an anode connected to the reference potential line 24. The freewheeling diode Dd11 may be a MOSFET, or may be an IGBT with a freewheeling diode connected in parallel, and further a modularized version of that.

In the current limiting means 22 in the present example, a connection point between the limiting switch SW13 and the freewheeling diode Dd11 is connected to the DC bus 30. The current I2 is limited by the limiting switch SW13. The current limiting inductor L2 may be provided between the connection point and the DC bus 30. An inductance component of the wiring may be used as the current limiting inductor L2.

The limiting switch SW13 may be a semiconductor switch. As an example, the limiting switch SW13 may be a MOSFET or an IGBT. In contrast to the mechanical switch such as a circuit breaker in which it takes tens of milliseconds for the on and off operation, the semiconductor switch can switch on and off in the order of microseconds. By causing the semiconductor switch to switch and smoothing the current flowing at that time by the inductor, the current limiting means 22 maintains a current value of the input current or the output current to be lower than or equal to a certain value greater than zero. The certain value may be greater than a current value during a steady operation or a rated current value; and may be five times or less, may be two times or less, may be 1.5 times or less, or may be 1.2 times or less of the current value.

For example, a value of a limitation current that the current limiting means 22 limits may be set, based on a unique parameter for a device, such as a rated current value of the battery 20 which is connected to the power conversion device 10 or an output rated current of the power conversion device 10. In this manner, in the system in FIG. 1, it is possible to set the value of the limitation current for each power conversion device 10, even when capacity of at least one battery of the plurality of batteries 20, and an overcurrent resistance capability of at least one power conversion device of the plurality of power conversion devices 10, or both are different.

The current limiting means 22 in the present example may cut off the current when the current value of the output current exceeds an upper limit value, and may cause the current to flow when the current value of the output current is lower than or equal to a lower limit value. This makes it possible for the output current to be maintained between the upper limit value and the lower limit value. When the current value of the output current exceeds the upper limit value, the current limiting means 22 may perform an on and off repetition at a predetermined duty ratio. The duty ratio may be a constant value regardless of the output current, and an on period may become shorter as the output current is increased. This makes it possible to suppress the output current. In the example of FIG. 2, by causing the limiting switch SW13 to switch and smoothing the current I2 by the current limiting inductor L2, it is possible to maintain the value of the current I2 to be lower than or equal to a certain value greater than zero. The operation at that time will be described below. The power conversion device 10 may include a control unit which controls each switch. The operation of each switch of the power conversion device 10 described in the present specification may be performed by the control unit.

The control unit may have a signal generation unit which supplies a gate signal to each switch.

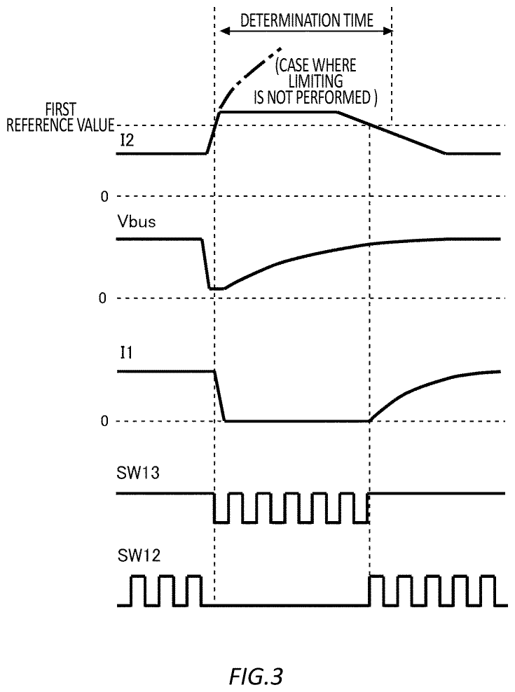

FIG. 3 is a diagram showing an example of a current limiting operation of the power conversion device 10 in FIG. 2. In FIG. 3, the current limiting operation is described by using a step-up time as an example. Under a normal condition, the power conversion device 10 switches the conversion switch SW12, and steps up the battery voltage Vbat to the bus voltage Vbus. The symbols SW13 and SW12 represent the gate signals of the limiting switch SW13 and the conversion switch SW12. Each switch is turned on when the gate signal is at an H level, and is turned off when it is at an L level. The limiting switch SW13 is always on for a period in which the current limiting is not performed during the step-up operation. In the present example as well, the limiting switch SW13 is a semiconductor switch. During a normal step-up operation in which the current limiting is not performed, the current I1 that is predetermined is input from the battery 20 to the power conversion device 10, and the power conversion device 10 outputs the current I2 that is predetermined to the DC bus 30. The DC bus has the bus voltage Vbus that is predetermined.

The present example shows, when the normal step-up operation is performed, a case where when the power conversion device 10 or a load device not shown is added to the DC bus 30, the capacitor C11 of the power conversion device 10 or a capacitor of the load device is charged from the DC bus 30; or a case where the DC bus 30 is temporarily short-circuited. An insertion of the capacitor refers to an insertion of the capacitor in parallel with the DC bus 30 between the high potential line 32 and the reference potential line 24 on the DC bus 30 side, and is performed, for example, when the power conversion device 10 is added or the like. A value of the current I2 in the DC bus is increased due to the insertion of the capacitor or the short circuit in the DC bus 30. The current limiting means 22 causes a semiconductor switch (the limiting switch SW13) to switch when the value of the current I2 in the DC bus 30 exceeds a first reference value. The first reference value may be a value of the rated current. In this manner, the current limiting means 22 controls the value of the current I2 to be lower than or equal to the certain value described above.

A switching frequency of the limiting switch SW13 at this time may be higher than a switching frequency of the conversion switch SW12 during the step-up operation. As an example, the switching frequency of the limiting switch SW13 is five times or more and ten times or less of the switching frequency of the conversion switch SW12. This makes it possible to reduce inductance of the current limiting inductor L2. For example, when there is a fivefold difference in the switching frequencies of the limiting switch SW13 and the conversion switch SW12, the inductance of the current limiting inductor L2 may be approximately one fifth of inductance of the inductor L1. In addition, when the inductance of the current limiting inductor L2 can be covered by inductance of the wiring, it is possible to omit the current limiting inductor L2.

A dash-single dotted line shown in a column of I2 in the figure indicates a behavior of the current I2 when the current is not controlled by the current limiting means 22. When the current is not controlled, the current I2 is increased rapidly.

When the limiting switch SW13 is in a switching state, the conversion switch SW12 is turned off. When the conversion switch SW12 is turned off, the voltage Vc of the capacitor C11 is greater than the battery voltage Vbat, and thus the current I1 is decreased to 0 A. In addition, the bus voltage Vbus is decreased due to the insertion of the capacitor or the short circuit in the DC bus 30.

In a case where the current value falls below the first reference value within a determination time, the power conversion device 10 may stop the switching of the limiting switch SW13 to maintain an on state, and start the switching of the conversion switch SW12. That is, the step-up operation may be resumed. When the capacitor is inserted into the DC bus 30, the current I2 is temporarily increased for charging the capacitor; however, once the capacitor is charged, the current I2 is decreased. In addition, in a case where the DC bus 30 is temporarily short-circuited, the current I2 is decreased when the short circuit is removed. In addition, in any case, the bus voltage Vbus is gradually increased. In a case where the current value falls below the first reference value within the determination time, the overcurrent is temporary. With the present example, the output current I2 is maintained at a predetermined current that is greater than zero within the determination time, and thus it is possible to resume the step-up operation immediately after the determination time elapses.

When the step-up operation is stopped, electric charges stored in the capacitor C11 of the non-isolated DC-DC converter 12 are discharged, and the voltage Vc of the capacitor C11 is decreased. The current I1 flows even when both of the step-down switch SW11 and the conversion switch SW12 are off, and thus the limiting switch SW13 is turned off as described below.

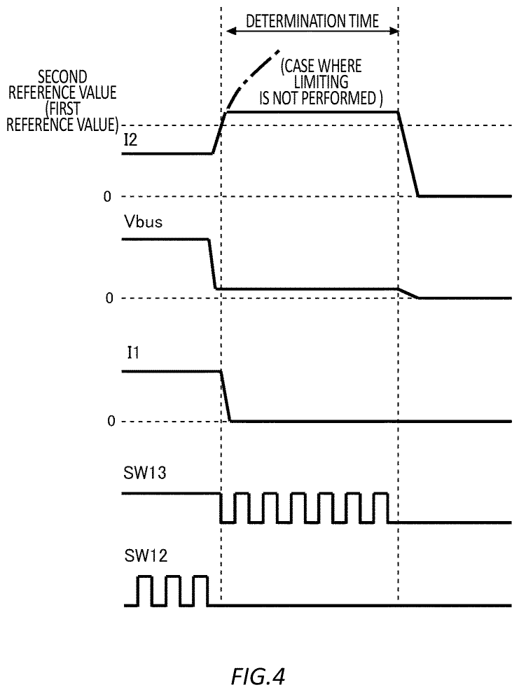

FIG. 4 is a diagram showing another example of the current limiting operation of the power conversion device 10 in FIG. 2. The power conversion device 10 in the present example also performs the step-up operation under the normal condition, similar to the case in FIG. 3. In addition, the symbol or the like in the figure is the same as that in FIG. 3. The present example shows a case where the DC bus 30 is continuously short-circuited.

When the DC bus 30 is short-circuited and the current I2 exceeds the first reference value, the limiting switch SW13 starts the switching and controls the current I2 to be lower than or equal to a certain value, which is similar to the case in FIG. 3. In addition, at that time, similar to the case of FIG. 3, the conversion switch SW12 stops the switching and is turned off.

In a case of the present example, the DC bus 30 is continuously short-circuited, and thus the current I2 does not fall below the first reference value even after the determination time elapses, and the bus voltage Vbus is not increased either. The fact that the current value does not fall below the first reference value even after the determination time elapses, is considered to be a short circuit due to a fault. When the current value does not fall below a second reference value after the determination time elapses, and the value of the bus voltage Vbus is not higher than or equal to a predetermined voltage value, the current limiting means 22 may cut off the input current or the output current. In a case of the present example, the second reference value is equal to the first reference value. The predetermined voltage value may be the value of the bus voltage Vbus under the normal condition, may be a value of 80% of the bus voltage Vbus under the normal condition, or may be a value of 50% of the bus voltage Vbus under the normal condition.

In a case of the present example, the current I2 is cut off by turning off the limiting switch SW13 which is switching after the determination time elapses. In this case, the conversion switch SW12 remains to be off. The current limiting means 22 may cut off the input current or the output current, when the current value of the current I2 does not fall below the second reference value at a point in time when the determination time elapses. The current limiting means 22 may cut off the input current or the output current, when the value of the bus voltage Vbus is not higher than or equal to a predetermined voltage value at a point in time when the determination time elapses.

In a case where the mechanical switch such as a circuit breaker or a fuse is used to protect the device from the overcurrent, it is not possible to cut off the current in a short time unless the current value is approximately 1000 times or more of a rated value. In addition, also in a case where the current value is temporarily increased due to the insertion of the capacitor or the temporary short circuit, rather than a fault in the DC bus 30, the voltage conversion operation of the power conversion device 10 is completely stopped, and it takes time to resume the voltage conversion operation. As shown in FIG. 3 and FIG. 4, by using a semiconductor switch to control the current value, it is possible to suppress the increase in current and monitor a behavior of the current during the determination time. This makes it possible to make a determination between a fault of the DC bus 30 and a temporary increase in the current value, and also makes it possible to resume the voltage conversion operation at a high speed. In addition, it is possible to suppress the rapid discharge of the electric charges stored in the capacitor C11.

The value of the current I2 is smaller than that of the current I1, and thus current capacity of the element of the current limiting means 22 may be small; and further, even when a fault is determined in the DC bus 30 and the current path is cut off, the current value is limited, and therefore the current capacity of the element only needs to match the rated current because there is no need to consider the condition of being 1000 times the rated value described above or the like. It should be noted that by separately providing a mechanical switch to cut off the current path, and turning off the mechanical switch, the current may be cut off. In that case, it is possible to obtain a similar effect. In this case, required cutoff capacity of the mechanical switch may also be equivalent to the rated value, rather than 1000 times or more of the rated value.

In the example of FIG. 4, the short circuit continues, and the limiting switch SW13 is turned off, and then a retry operation to turn on the limiting switch SW13 again manually or automatically may be performed. When the value of the current I2 at that time is lower than or equal to the second reference value, the operation may transition to the normal step-up operation, and when the value of the current I2 is greater than the second reference value, the limiting switch SW13 may be turned off again. As an example, the retry operation may be performed up to a maximum of three times until the operation transitions to the normal step-up operation. Alternatively, in a case where the retry operation is performed once and the short circuit continues, the retry operation may not be performed until a cause of the short circuit is removed.

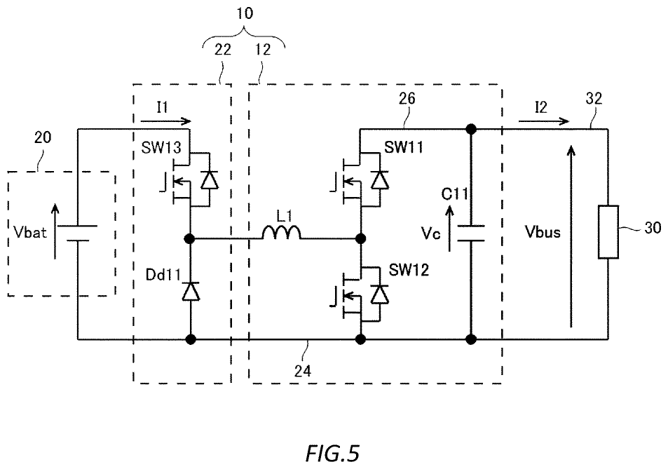

FIG. 5 is a diagram showing another arrangement example of the power conversion device 10, the battery 20, and the DC bus 30. A configuration of the non-isolated DC-DC converter 12, the battery 20, and the DC bus 30 in the present example is similar to that in the example of FIG. 2, except that each switch is a MOSFET. The current limiting means 22 in the present example is provided between the battery 20 and the inductor L1. In the present example, the reference potential line 24 may be common to the battery 20, the power conversion device 10, and the DC bus 30. In addition, the high potential line 26 may be connected to the high potential line 32.

The current limiting means 22 in the present example may also be a switch. The switch may be a semiconductor switch such as a transistor, or may be a mechanical switch. The current limiting means 22 in the present example also has the limiting switch SW13 and the freewheeling diode Dd11. Note that the limiting switch SW13 in the present example is connected to the battery 20. In addition, in the present example, the freewheeling diode Dd11 is provided between the limiting switch SW13 and the reference potential line 24. The freewheeling diode Dd11 in the present example has a role of ensuring the current path of the current flowing through the inductor L1 during the off period of the limiting switch SW13. The freewheeling diode Dd11 in the present example also has a cathode connected to the limiting switch SW13 and an anode connected to the reference potential line 24. The limiting switch SW13 in the present example is a MOSFET which is a type of a semiconductor switch. A connection point between the limiting switch SW13 and the freewheeling diode Dd11 is connected to the inductor L1.

In a case where the non-isolated DC-DC converter 12 is operated as a step-up chopper, the limiting switch SW13 is turned on, and the conversion switch SW12 switches. In addition, in a case of being operated as a step-down chopper, the step-down switch SW11 switches.

The current limiting during the step-up operation will be described. The current limiting means 22 in the present example limits the input current to the non-isolated DC-DC converter 12. In the present example, the limiting switch SW13 switches, and the current I1 flowing at that time is smoothed by the inductor L1, thereby limiting the input current. In the present example as well, the current limiting means 22 may maintain the current value of the input current or the output current to be lower than or equal to a certain value greater than zero, similar to the case in FIG. 2. In a case of the present example, it is possible to use the inductor L1 of the non-isolated DC-DC converter 12 as the current limiting means 22, and thus it is possible to reduce the number of components. In addition, the battery voltage Vbat that is lower than the bus voltage Vbus is applied to the current limiting means 22, and thus it is possible to make a design for a breakdown voltage of the element to be low. The limiting switch SW13 in the present example may be a MOSFET, and the step-down switch SW11 and the conversion switch SW12 may be IGBTs. In addition, the power conversion device 10 may include a control unit, similar to the case in FIG. 2.

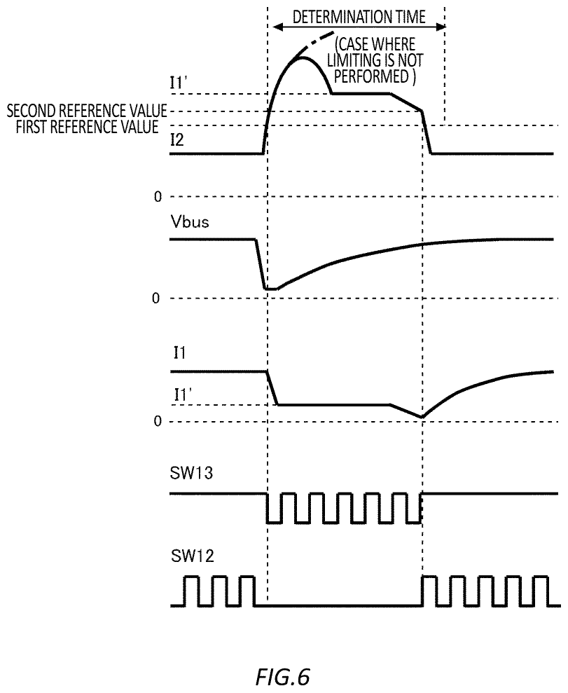

FIG. 6 is a diagram showing an example of the current limiting operation of the power conversion device 10 in FIG. 5. Similar to the case in FIG. 3, under the normal condition in which the current limiting is not performed, the power conversion device 10 in the present example switches the conversion switch SW12, and steps up the battery voltage Vbat to the bus voltage Vbus. The symbol or the like that overlaps with that of FIG. 3 refers to what is similar to that in FIG. 3, and thus the description will be omitted.

The present example also shows, when the normal step-up operation is performed, a case where the capacitor is inserted into the DC bus 30 or the DC bus 30 is temporarily short-circuited. The value of the current I2 in the DC bus is increased due to the insertion of the capacitor or the short circuit in the DC bus 30. The current limiting means 22 causes a semiconductor switch (the limiting switch SW13) to switch when the value of the current I2 in the DC bus 30 exceeds the first reference value. The first reference value may be a value of the rated current in the present example as well.

When the limiting switch SW13 switches, the current I1 is limited. The current I1 limited here is referred to as a current I1′. On the other hand, in a case of the present example, the current limiting means 22 is provided between the battery 20 and the non-isolated DC-DC converter 12, and thus the electric charges stored in the capacitor C11 are released all at once to cause the current I2 to be increased rapidly. After the release of the electric charges from the capacitor C11, the value of the current I2 becomes equal to a value of the current I1′. The current limiting means 22 controls the value of the current I2 to be lower than or equal to a certain value. Here, the certain value in the present example may be the value of the current I1′, and the temporary increase in current value due to the discharge of the capacitor may be excluded.

A dash-single dotted line shown in a column of I2 in the figure indicates a behavior of the current I2 when the current is not controlled by the current limiting means 22. When the current is not controlled, the battery 20 is discharged, and the current I2 is increased rapidly.

Similar to the case of FIG. 3, in the present example, as the capacitor inserted into the DC bus 30 is charged, or as the short circuit is removed, the bus voltage Vbus of the DC bus 30 is increased. Along with that, the value of the current I2 is decreased.

In a case where the current value falls below the second reference value within the determination time, the power conversion device 10 may stop the switching of the limiting switch SW13 to maintain an on state again, and start the switching of the conversion switch SW12. That is, the step-up operation may be resumed. The second reference value may be equal to the first reference value, may be 80%, may be 50%, or may be 30% of the value of the current I1′. In a case where the current value falls below the second reference value within the determination time, the overcurrent is temporary, and according to the present example, it is possible to resume the step-up operation immediately. The determination time may include a period after the voltage Vc of the capacitor C11 becomes smaller than the battery voltage Vbat, which is different from the case in FIG. 3.

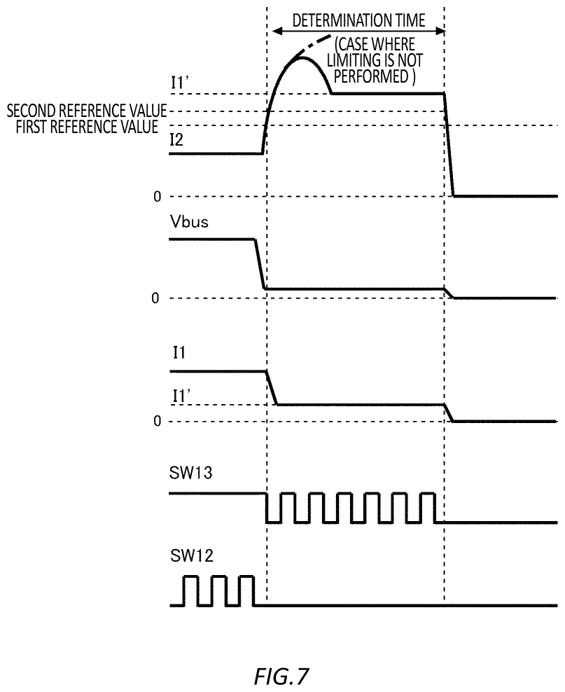

FIG. 7 is a diagram showing another example of the current limiting operation of the power conversion device 10 in FIG. 5. Similar to the case in FIG. 6, under the normal condition in which the current limiting is not performed, the power conversion device 10 in the present example also performs the step-up operation. In addition, the symbol or the like in the figure is the same as that in FIG. 6. The present example shows a case where the DC bus 30 is continuously short-circuited.

When the DC bus 30 is short-circuited and the current I2 exceeds the first reference value, the limiting switch SW13 starts the switching and controls the current I1 to the current I1′, which is similar to the case in FIG. 6. In addition, at that time, similar to the case of FIG. 6, the conversion switch SW12 stops the switching to be in an off state.

In a case of the present example, the DC bus 30 is continuously short-circuited, and thus the current I2 does not fall below the second reference value even after the determination time elapses, and the bus voltage Vbus is not increased either. The fact that the current value does not fall below the second reference value even after the determination time elapses is considered to be a short circuit due to a fault. Therefore, when the current value does not fall below the second reference value after the determination time elapses, and the value of the bus voltage Vbus is not higher than or equal to a predetermined voltage value, the current limiting means 22 may cut off the input current or the output current. The predetermined voltage value may be the value of the bus voltage Vbus under the normal condition, may be a value of 80% of the bus voltage Vbus under the normal condition, or may be a value of 50% of the bus voltage Vbus under the normal condition.

In a case of the present example, the current I1 is cut off by bringing, into an off state, the limiting switch SW13 which is switching after the determination time elapses. The current limiting means 22 may cut off the input current or the output current, when the value of the current I2 does not fall below the second reference value at a point in time when the determination time elapses. The current limiting means 22 may cut off the input current or the output current, when the value of the bus voltage Vbus is not higher than or equal to a predetermined voltage value at a point in time when the determination time elapses. In addition, a retry operation similar to that in FIG. 4 may be performed.

Similar to the cases in FIG. 3 and FIG. 4, in the present example as well, by using a semiconductor switch to control the current value, and monitoring a behavior of the current value during the determination time by a constant current operation, it is possible to make a determination between a fault of the DC bus 30 and a temporary increase in the current value, and it is also possible to resume the voltage conversion operation at a high speed. Further, even when a fault is determined in the DC bus 30 and the current path is cut off, the current value is limited, and therefore the current capacity of the element may be low. It should be noted that in the present example as well, by separately providing a mechanical switch to cut off the current path, and turning off the mechanical switch, the current may be cut off.

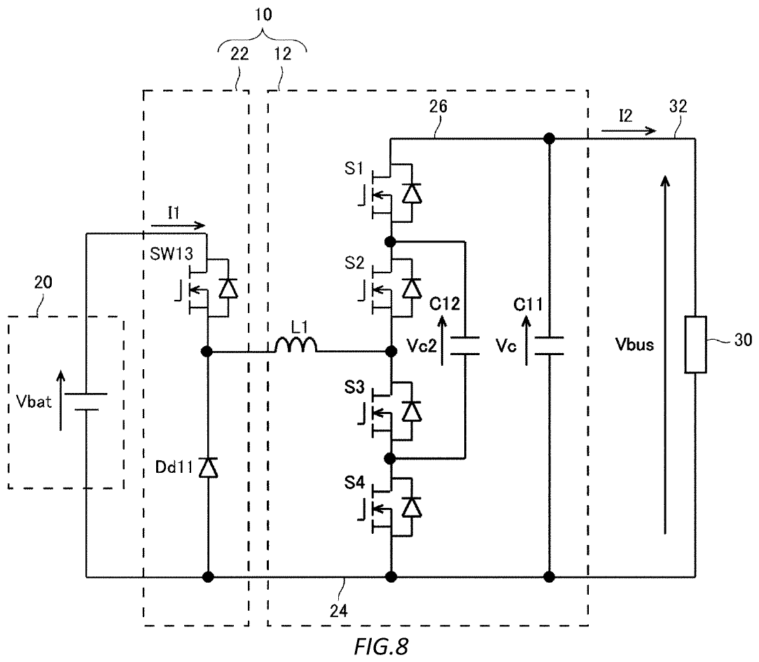

FIG. 8 is a diagram showing another configuration example of the power conversion device 10. The power conversion device 10 in the present example has a different configuration of the non-isolated DC-DC converter 12 in comparison with that of the power conversion device 10 in FIG. 5. The current limiting means 22 in the present example is provided between the battery 20 and the non-isolated DC-DC converter 12, but may be provided between the non-isolated DC-DC converter 12 and the DC bus 30 as shown in FIG. 2. The operation of the current limiting means 22 is similar to the operations described in FIG. 2 to FIG. 7, and thus the description will be omitted.

Similar to FIG. 2 and FIG. 5, the power conversion device 10 in the present example includes the reference potential line 24 set to a reference potential, and the high potential line 26 which has a potential higher than the reference potential by the voltage Vc of the capacitor C11. The non-isolated DC-DC converter 12 in the present example has four switches provided in series between the high potential line 26 and the reference potential line 24. Four switches are referred to as a first switch S1, a second switch S2, a third switch S3, and a fourth switch S4, starting from a high potential line 26 side. The non-isolated DC-DC converter 12 has the inductor L1 connected on one side between the second switch S2 and the third switch S3. The non-isolated DC-DC converter 12 has a second capacitor C12 provided in parallel with the second switch S2 and the third switch S3. That is, the non-isolated DC-DC converter 12 in the present example is a chopper of a three-level flying capacitor type.

Similar to the modes shown in FIG. 2 and FIG. 5, the reference potential line 24 is also common to the battery 20, the power conversion device 10, and the DC bus 30 in the present example, and thus even when each switch performs the switching operation, a high frequency voltage does not occur between the battery 20 and the DC bus 30. In addition, with the non-isolated DC-DC converter 12 in the present example, it is possible to easily create a high step-up ratio (the bus voltage Vbus/the battery voltage Vbat), and thus it is possible to handle a high bus voltage Vbus. Further, when a voltage Vc2 of the second capacitor C12 is set to half of the bus voltage Vbus, the voltage applied to each switch is also half of the bus voltage Vbus, and thus it is possible to suppress the breakdown voltage of the element to a value equivalent to half of the bus voltage Vbus.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

What is claimed is:

1. A power conversion device comprising:
a non-isolated DC-DC converter which is provided between a battery and a DC bus to which one or more batteries, each of which is the battery, are connected and a bus voltage is applied; and
a current limiting means which limits at least one of an input current to the non-isolated DC-DC converter or an output current from the non-isolated DC-DC converter, wherein
the non-isolated DC-DC converter performs an operation to convert a battery voltage of the battery to the bus voltage for outputting to the DC bus when the battery is discharged, and performs an operation to convert the bus voltage to the battery voltage for outputting to the battery when the battery is charged, and
the current limiting means is connected between the non-isolated DC-DC converter and the battery, or between the non-isolated DC-DC converter and the DC bus.

2. The power conversion device according to claim 1, wherein
the current limiting means limits at least one of the input current or the output current of the non-isolated DC-DC converter, independently of the conversion operation of the non-isolated DC-DC converter.

3. The power conversion device according to claim 1, the power conversion device further comprising:
a reference potential line set to a reference potential, wherein
the current limiting means is a circuit in which a limiting switch which limits a current and a freewheeling diode are connected in series,
an anode of the freewheeling diode is connected to the reference potential line,
the limiting switch is connected to an input unit or an output unit of the non-isolated DC-DC converter, and
a connection point between the limiting switch and the freewheeling diode is connected to the input unit or the DC bus.

4. The power conversion device according to claim 3, wherein
the limiting switch is a semiconductor switch.

5. The power conversion device according to claim 4, wherein
the current limiting means maintains a current value of the input current or the output current to be lower than or equal to a certain value greater than zero.

6. The power conversion device according to claim 5, wherein
when a current value of the DC bus exceeds a first reference value, the current limiting means controls the current value to be lower than or equal to the certain value by switching the semiconductor switch, and when the current value does not fall below a second reference value after a determination time elapses, and a value of the bus voltage is not higher than or equal to a predetermined voltage value, the current limiting means cuts off the input current or the output current.

7. A power storage system comprising:
a plurality of power conversion devices, each of which is the power conversion device according to claim 1; and
the plurality of batteries connected to the power conversion devices, respectively.

8. The power storage system according to claim 7, further comprising:
the DC bus to which the plurality of power conversion devices are connected, and which is common; and
a power conditioner which is connected to the DC bus.
